(19) United States
(12) Patent Application Publication
(10) Pub. No.: US 2010/0110054 A1
(43) Pub. Date: May 6, 2010

(54) DISPLAY MODULE AND METHOD FOR USING THE SAME

(75) Inventor: DE-FENG GAO, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (HONG KONG) Limited, Kowloon (HK)

(21) Appl. No.: 12/484,311

(22) Filed: Jun. 15, 2009

(30) Foreign Application Priority Data
Oct. 31, 2008 (CN) 200810305328.9

(51) Int. Cl. G09G 5/00

(52) U.S. Cl. 345/211; 345/1.3

(57) ABSTRACT

A display module used in a portable electronic device includes a display unit and a processor unit. The display unit includes a main display and a subsidiary display electronically connected to the main display. The processor unit is electronically connected to the display unit. The processor unit sends signals received by the portable electronic device to the display unit to display images of the signals. The processor unit identifies the signals and selects either of the two display modes according to the identifying results. The images of the signals are displayed in both the main display and the subsidiary display when a common display mode is selected, and the images of the signals are displayed in only the subsidiary display when an energy-saving display mode is selected.

### BACKGROUND

1. Technical Field

The present invention relates to display modules and method for using the same, and particularly to a display module that uses less power and a method for using the same.

2. Description of Related Art

Display modules are widely used in portable electronic devices such as mobile phones or personal digital assistants (PDA). With the development of technology, display modules are provided with enlarged sizes, variety of colors, and high definition. However, these enlarged/multicolored/high definition display modules consume much more electric power.

Many display modules can have a standby status to save electric power. When a display module of a portable electronic device works in a standby status, the display module is in a black-screen status. In the black-screen status, the display module stops displaying images and turns off its backlight to save electric power. When the portable electronic device receives alerting signals such as telephone calls or short message, or the user inputs instruction to the portable electronic device, the display module changes to a display status, thus the display module turns on the backlight, thereby displaying images.

When a display module of a portable electronic device switches from the standby status to the display status, despite the fact that information/instructions received by the portable electronic device can be displayed in only a part of a screen of its display module and/or in only black and white, the display module will turn on all of its backlight, and the whole screen of the display module will become multicolor and display information/instruction. Therefore, the conventional portable electronic device consumes a larger amount of electric power.

Therefore, there is room for improvement within the art.

### BRIEF DESCRIPTION OF THE DRAWINGS

Many aspects of the present display module and method for using the same can be better understood with reference to the following drawings. The components in the various drawings are not necessarily drawn to scale, the emphasis instead being placed upon clearly illustrating the principles of the present display module and method fro using the same. Moreover, in the drawings, like reference numerals designate corresponding parts throughout the figures.

FIG. 1 is a schematic view of a display module, according to an exemplary embodiment.

FIG. 2 is a block diagram of the display module shown in FIG. 1.

FIG. 3 is a flow chart of an image displaying method, according to an exemplary embodiment.

### DETAILED DESCRIPTION

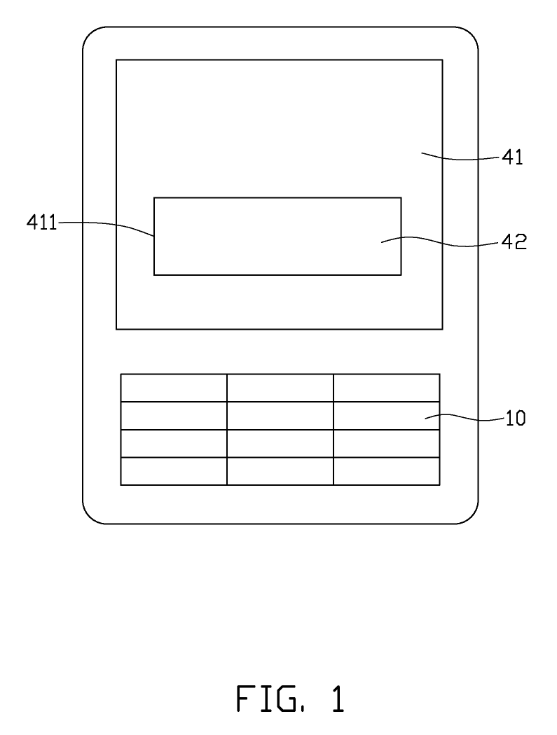

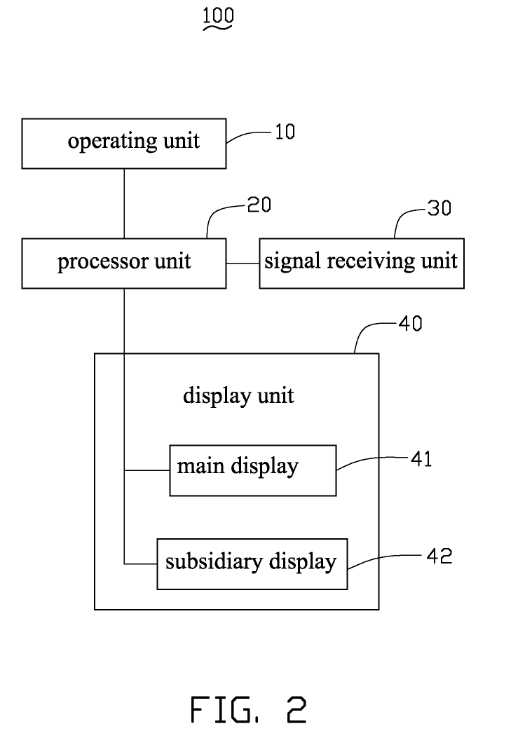

Referring to FIG. 1 and FIG. 2, a display module 100 according to an exemplary embodiment is provided. The display module 100 is used in a portable electronic device such as a mobile phone, a personal digital assistant (PDA) or a laptop computer to display images.

The display module 100 includes an operating unit 10, a processor unit 20, a signal receiving unit 30 and a display unit 40. The operating unit 10, the signal receiving unit 30 and the display unit 40 are all electronically connected to the processor unit 20. The operating unit 10 is an input apparatus such as a keypad for inputting operating instruction to the display module 100. The processor unit 20 can be a CPU of the portable electronic device for processing the operating instructions and controlling the display unit 40 to work according to the operating instruction. The signal receiving module 30 can be an antenna of the portable electronic device for receiving outside wireless signals and sending the signals to the processor unit 20, thereby displaying images.

The display unit 40 includes a main display 41 and a subsidiary display 42. The main display 41 and the subsidiary display 42 are both electronically connected to the processor unit 20. The subsidiary display 42 is also electronically connected to the main display 41, and the electronic connection between the main display 41 and the subsidiary display 42 is controlled by the processor unit 20.

The main display 41 can be a conventional display of the portable electronic device. The main display 41 has a display status and a standby status. In the display status, the main display 41 turns on its backlight and displays images in colors. In the standby status, the main display 41 turns off its backlight and stops displaying images. The subsidiary display 42 is a relatively small display, which has a common display status and a standby status similar to the display status and the standby status of the main display 41. The subsidiary display 42 further has a special display status. In the special display status, the subsidiary display 42 displays images in less colors (e.g., only in black and white) less than the number of kinds of colors used in the common display status.

Understandably, in one fabricating method, a whole display is premade and then be divided into a subsidiary display 42 and a main display 41; in another fabricating method, the main display 41 and the subsidiary display 42 are made separately, and then assembled together. In assembly, the subsidiary display 42 can be mounted on a surface of the main display 41 or received in a corresponding hole 411 defined in the main display 41.

The display module 100 has a standby mode, a common display mode and an energy-saving display mode. In the standby mode and the common display mode, the subsidiary display 42 is electronically connected to the main display 41. The subsidiary display 42 is integrated with the main display 41 to serve as a part of the main display 41, and thus the main display 41 and the subsidiary display 42 can display images together in the aforementioned display status/common display status, respectively, or both switch to the standby status to stop displaying images. In the energy-saving mode, the electronic connection between the main display 41 and the subsidiary display 42 is switched off by the processor unit 20. The subsidiary display 42 serves as an independent display, and thus the subsidiary display 42 can display images in either the common display status or the special display status.

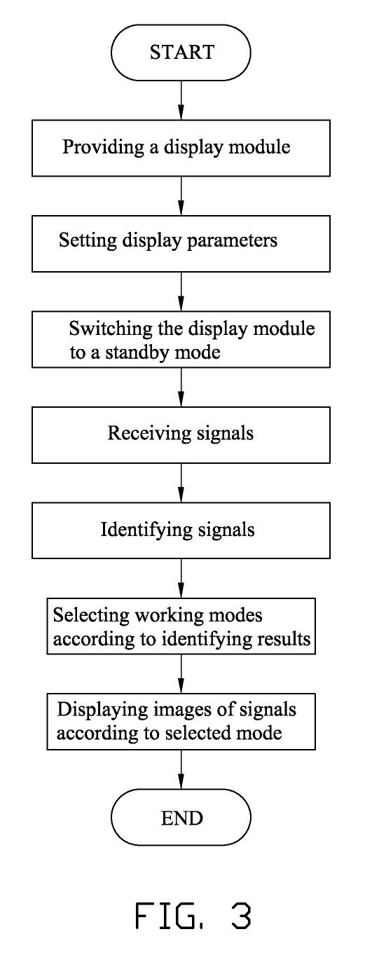

Also referring to FIG. 3, an image display method according to an exemplary embodiment is provided. The method includes these steps as follows.

First, a display module 100 is provided and installed in a portable electronic device, such as a mobile phone, a personal digital assistant (PDA) or a laptop computer.

Display parameters of the display unit 40 (e.g., the number and colors used to display images, luminance of the backlight, and definition of displayed images, etc.) are set in the processor module 20 by the operating module 10. Advantageously, the display status of the main display 41 and the common display status of the subsidiary display 42 use relatively more kinds of colors, higher luminance of backlight and higher definition, and the special display status of the subsidiary display 42 use relatively less kinds of colors, lower backlight luminance and lower definition.

After setting display parameters, the display module 100 automatically switches or is manually switched to the standby mode. The subsidiary display 42 is electronically connected to the main display 41, and both the main display 41 and the subsidiary display 42 are in their above-mentioned standby statuses.

When outside signals, such as inputted instruction, telephone calls, messages or pictures are received by the portable electronic device, the signal receiving unit 30 sends the signals to the processor unit 20. The processor unit 20 then identifies the kinds of the received signals, selects from different working modes of the display module 100 according to the identifying results, and then sends the signals to the display unit 100 to display according to selected working modes.

In particular, when the processor unit 20 identifies the received signals as character signals (e.g., telephone calls or character messages) or simple image signals that do not require a large display size nor many display colors, the processor unit 20 selects the energy-saving display mode. Thus, the processor unit 20 switches off the electronic connection between the main display 41 and the subsidiary display 22. The main display 41 maintains functioning in the standby status to save electric energy, and the subsidiary display 22 independently displays images of the signals, i.e., the phone numbers or characters, in less colors or just in black and white, with relatively low brightness and definition. Correspondingly, only a part of backlight corresponding to the subsidiary display 42 is turned on. Therefore, only a part of the display unit 100 displays images, and the display module 100 can save electric energy.

When processor unit 20 identifies the received signals as image signals requiring a large display size and many display colors, for example, pictures or webpages, the processor unit 20 selects the common display mode. Thus, the processor unit 20 mains functioning the electronic connection between the main display 41 and the subsidiary display 42. The images are displayed in the main display 41 and the subsidiary display 42 integrated together, wherein the entire backlight is turned on, and the images are displayed in all colors of the display unit 40, with relatively higher brightness and definition. Therefore, the display parameters such as size, luminous, colors and definition of the displayed images are all improved, such that the images get high display quality.

Additionally, in the method embodiment, the aforementioned step of setting display parameters can also be omitted. Instead, the processor unit 20 can automatically determine display parameters when the received signals have been identified.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A display module used in a portable electronic device, comprising:
a display unit including a main display and a subsidiary display electronically connected to the main display;
a processor unit electronically connected to the display unit, the processor unit sending signals received by the portable electronic device to the display unit to display images of the signals; wherein the display module has a common display mode and an energy-saving display mode, the processor unit identifying the signals and selecting either of the two display modes according to the identifying results; and the images of the signals are displayed using both the main display and the subsidiary display when the common display mode is selected, and the images of the signals are displayed using only the subsidiary display when the energy-saving display mode is selected.

2. The display module as claimed in claim 1, wherein the electronic connection between the main display and the subsidiary display is switched on in the common display mode, and is switched off in the energy-saving display mode.

3. The display module as claimed in claim 1, further comprising an operating unit electronically connected to the processor unit to operate instruction.

4. The display module as claimed in claim 1, further comprising a signal receiving unit electronically connected to the processor unit to receive outside signals.

5. The display module as claimed in claim 1, wherein images are displayed in the main display and the subsidiary display in relatively more colors, higher luminous and higher definition, and images are displayed in the subsidiary display in relatively less colors, lower luminous and lower definition.

6. A method for displaying images in a portable electronic device, comprising:
providing a display module installed in the portable electronic device;
receiving outside signals;
identifying the kinds of the signals and selecting display modes according to the selecting results; and
using the display module to display the images of the signals according to selected display mode.

7. The method as claimed in claim 6, further comprising a step of setting displaying parameters corresponding to different display modes.

8. The method as claimed in claim 6, further comprising a step of selecting a common display mode and using a main display of the display module and a subsidiary display of the display module integrated with the main display to display images together.

9. The method as claimed in claim 8, further comprising a step of selecting an energy-saving display mode and using the subsidiary display to independently display images.

10. The method as claimed in claim 8, further comprising a step of switching the display module to a standby mode, wherein the main display and the subsidiary display both stop displaying images.
